(19) United States
(12) Patent Application Publication
(10) Pub. No.: US 2003/0165376 A1
(43) Pub. Date: Sep. 4, 2003

(54) EXTRAVEHICULAR APPARATUS FOR LOADING AND SECURING CARGO

(75) Inventors: MICHAEL ROMAN BRUNO, OCONOMOWOC, WI (US); ROBERT MONROE BOYD, WATERTOWN, WI (US); JOSEPH RUSSELL ROUTHIER, WAUKESHA, WI (US)

Correspondence Address: C THOMAS SYLKE, SYLKE LAW OFFICES, 756 NORTH MILWAUKEE ST, SUITE 310, MILWAUKEE, WI, 53202

(73) Assignee: C THOMAS SYLKE

(21) Appl. No.: 09/430,716

(22) Filed: Oct. 29, 1999

(51) Int. Cl. B60P 9/00

(52) U.S. Cl. 414/462

(57) ABSTRACT

A device for raising and securing a scooter to the outside of a vehicle includes a slide tube assembly, a platform assembly attached to the slide tube assembly, a logic tube assembly and a hold tight arm assembly. The device automatically detects whether cargo of a preselected minimum weight is present on the platform and, on that basis, controls pivoting of the platform between open and closed positions and controls movement of the hold tight arm between retracted and extended positions.

### CROSS-REFERENCE TO RELATED APPLICATIONS

Not Applicable.

### STATEMENT REGARDING FEDERALLY SPONSORED RESEARCH OR DEVELOPMENT

Not Applicable. REFERENCE TO A MICROFICHE APPENDIX

Not Applicable.

### BACKGROUND OF THE INVENTION

1. Field of the Invention

The present invention relates generally to devices used to load, secure and transport various types of cargo, including motorized personal transportation vehicles, commonly called “scooters.” These vehicles typically are used by physically challenged individuals and others is with impaired mobility, such as elderly individuals. More particularly, the present invention relates to an apparatus intended to be mounted to the outside of a motor vehicle and designed to sense automatically whether a scooter is present on the lift platform of the device. If a scooter is present, the apparatus raises the vehicle and secures it on the platform. If no such vehicle is present, then the lift platform is stored in a secured position.

Even more particularly, the present invention includes an improved mechanism for securing a scooter to the lift platform, using the floor pan of the scooter as the base for securing the scooter. Also, the present invention includes an improved logic mechanism for automatically determining whether cargo of a predetermined weight is present on the lift platform as the platform is raised. Also, the lift platform utilizes an improved cam configuration which relieves stress on the actuator when cargo is held on the platform in a raised position. Finally, a latch/handle for operating the actuator uses an improved latching configuration that locks the lift mechanism in its raised position when the handle is not in use.

2. Description of Related Art

In the past, extravehicular hoists have been able to lift and secure cargo on a lift platform, automatically sensing whether cargo (such as a scooter) was present on the lift platform. An example of a device is the apparatus disclosed and claimed in U.S. Pat. No. 5,567,107, issued Oct. 22, 1996. That patent and the disclosure contained therein is incorporated herein by reference. The device disclosed in U.S. Pat. No. 5,567,107 is sold by Bruno Independent Living Aids. Inc. of Oconomowoc, Wis. under the OUTSIDER trademark.

While the device of U.S. Pat. No. 5,567,107 did not present any problems to manufacturers and operators of the device, the improvements embodied in the present invention enhance the manufacture, maintenance and operation of the mechanism used to secure a scooter to the platform, the logic mechanism, the cam configuration of the lift platform and the latching handle configuration.

The hoist device of the present invention represents a significant advancement in the art.

### BRIEF SUMMARY OF THE INVENTION

The advantages, improvements and benefits of the present invention can be realized in an adjustable support base for mounting a portable vehicle hoist to a surface. The device includes a slide tube assembly, a platform assembly pivotably attached to the slide tube assembly, a logic tube assembly and a hold tight arm assembly. As the slide tube assembly is retracted, the slide tube assembly attempts to compress the logic tube assembly. A spring loaded biasing mechanism on the logic tube assembly detects whether cargo of a preselected weight is present on the platform, based on the torque exerted by the platform as the logic tube assembly attempts to pivot the platform to a vertical, closed position.

If cargo is detected, then the platform remains in its horizontal, open position. At the same time, the hold tight arm is pivoted outwardly from its retracted position to apply a downward holding pressure on the cargo. Because the hold tight arm does not come over the top of the cargo, the arm cannot engage and/or damage any upper portions of the cargo, such as the steering mechanism or seat on a personal transportation device such as a scooter. The hold tight arm holds such a scooter on the platform by applying the downward pressure to the floor of the scooter.

If no cargo is present on the platform, then the platform is rotated to its vertical, closed position. The hold tight arm remains in its retracted position.

Because the logic mechanism is located directly behind the slide tube assembly, rather than to one side, the forces applied within the logic mechanism are more balanced (that is, offset loading is avoided), and the hold tight arm can be centered, thus permitting greater versatility in the devices loading and securing of cargo. The use of separate slide tube and logic tube assemblies makes the device easier to assemble, maintain and repair and creates a lower device profile (reducing the risk of obstruction of the line of sight in a vehicle rear view mirror). A new latching configuration in the handle controlling operation of the actuator physically locks the slide tubes in their compressed position, reducing the risk of slippage when the platform is raised, especially if a scooter or other cargo is being stored or transported.

In this way, the device automatically detects whether cargo of a preselected minimum weight is present on the platform and, on that basis, controls pivoting of the platform between open and closed positions and controls movement of the hold tight arm between retracted and extended positions.

### BRIEF DESCRIPTION OF THE SEVERAL VIEWS OF THE DRAWING

FIG. 1 is a perspective view of the preferred embodiment of the present invention, showing the lift device secured to a motor vehicle M with the platform resting on a surface S.

FIG. 2 is a side perspective view of the preferred embodiment of the present invention.

FIG. 3 is a side perspective view of the preferred embodiment of the present invention, showing the platform in a partially raised position in solid lines, and showing the platform in its lowered position, resting on a support surface S in broken lines.

FIG. 4 is a side perspective view of the preferred embodiment of the present invention, showing the platform in its raised storage position.

FIG. 5 is a side perspective view of the preferred embodiment of the present invention, showing the platform in a partially raised position in solid lines, and showing a scooter on the platform in broken lines.

FIG. 6 is a side perspective view of the preferred embodiment of the present invention, showing the platform in its raised loaded position, and showing a scooter on the platform in broken lines.

FIG. 7 is a side sectional view of the logic mechanism, part of the slide tube assembly and the hold tight arm assembly of the preferred embodiment of the present invention.

FIG. 8 is a side sectional view of the latch and handle assembly of the preferred embodiment of the present invention.

FIG. 9 is front, partial sectional view of the follower cam and roller components of the preferred embodiment of the present invention.

FIG. 10 is a side perspective view of one of the follower cams of the present invention and a multiplicity of positions of one of the rollers engaging the cam.

FIG. 10a is a side perspective view of one of the follower cams of the present invention and the position of one of the rollers engaging the cam in the position of the preferred embodiment of the present invention shown in solid lines in FIG. 3.

FIG. 10b is a side perspective view of one of the follower cams of the present invention and the position of one of the rollers engaging the cam in the position of the preferred embodiment of the present invention shown in FIG. 4.

FIG. 10c is a side perspective view of one of the follower cams of the present invention and the position of one of the rollers engaging the cam in the position of the preferred embodiment of the present invention shown in FIG. 6.

FIG. 11 is a top sectional view of the latch and handle assembly of the preferred embodiment of the present invention, taken along the line 11-11 of FIG. 8.

FIG. 12 is a top sectional view of the latch and handle assembly of FIG. 11, showing the handle in a raised position.

FIG. 13 is a top sectional view of the latch and handle assembly of FIG. 12, showing rotation of the handle to its “up” position in solid lines and rotation of the handle to its “down” position in broken lines.

In the FIGURES, like reference numerals refer to like components.

### DETAILED DESCRIPTION OF THE INVENTION

The present invention is an electrically powered hoist designed for loading, securing and transporting various types of cargo. It is particularly helpful in loading, securing and transporting personal transportation devices (commonly called “carts” and “scooters”) such as those used by the elderly and individuals who are physically challenged with respect to personal mobility. While the present invention is not limited to any particular type of cargo which might be secured and transported, the preferred embodiment of the present invention will be described and illustrated in connection with its use to load, secure and transport a personal mobility device known as a scooter.

The hoist device of the present invention is designed to be mounted to a motor vehicle such as an automobile or a van. In the preferred embodiment, the device can be mounted to the motor vehicle by means of a Class III hitch. The preferred embodiment will be discussed in the context of loading and securing a scooter weighing 300 pounds or less. Changes constituting matters of design choice can be made to adapt the present invention to use with other types of cargo having different characteristics as to weight, size and the like.

### General Configuration

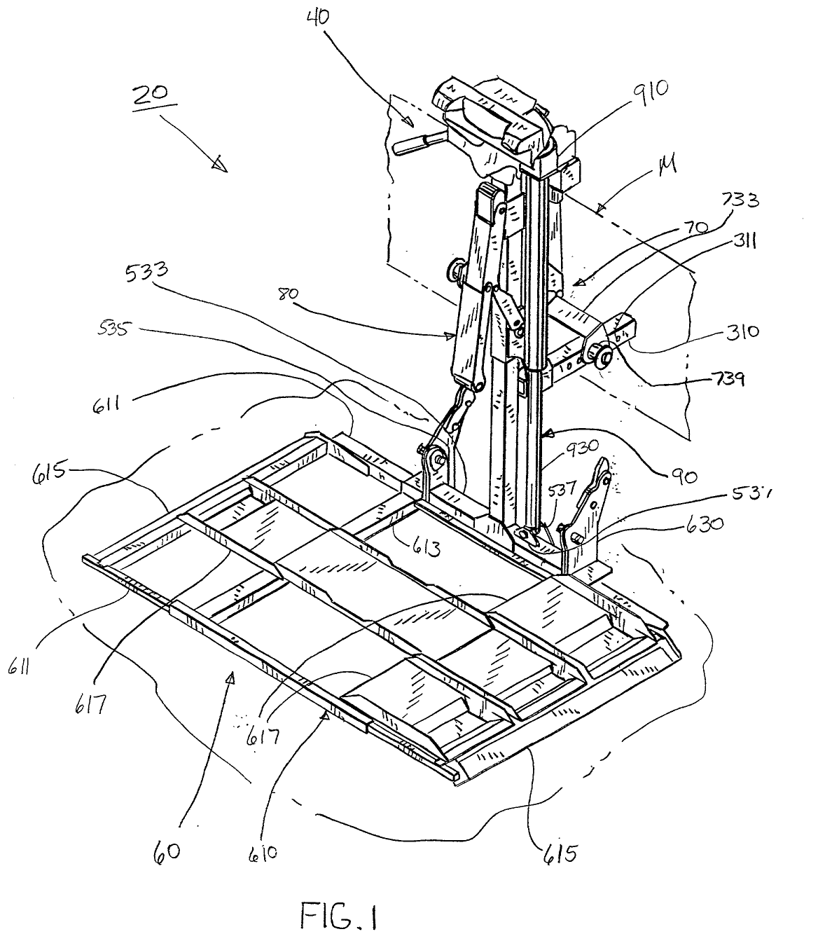

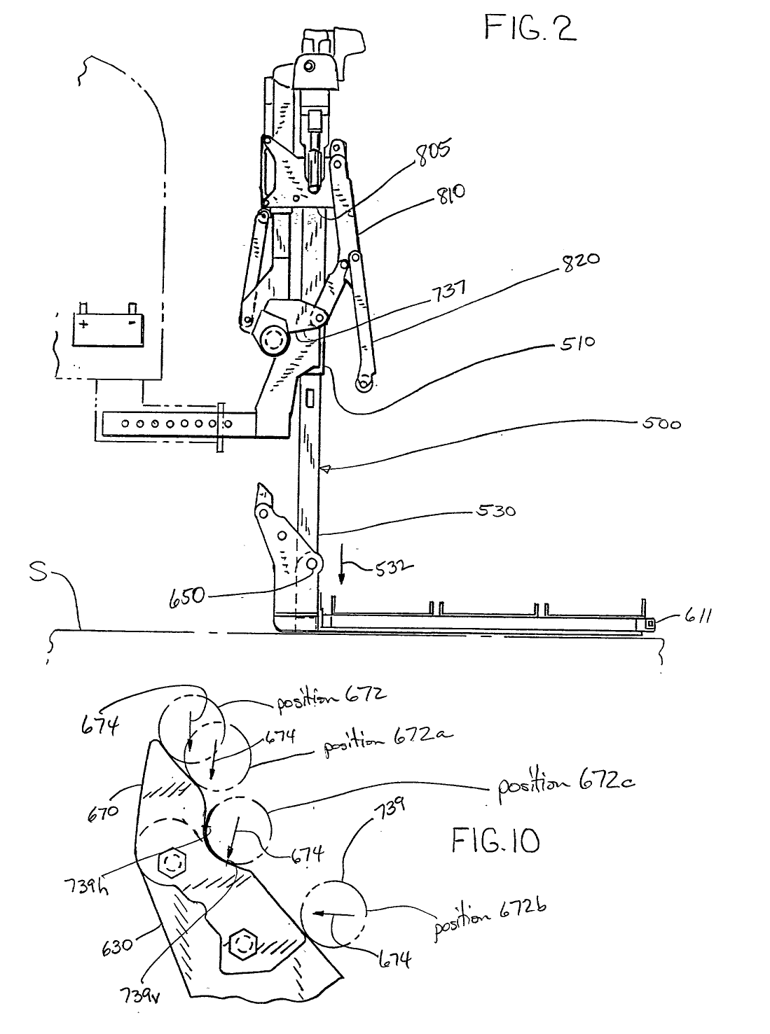

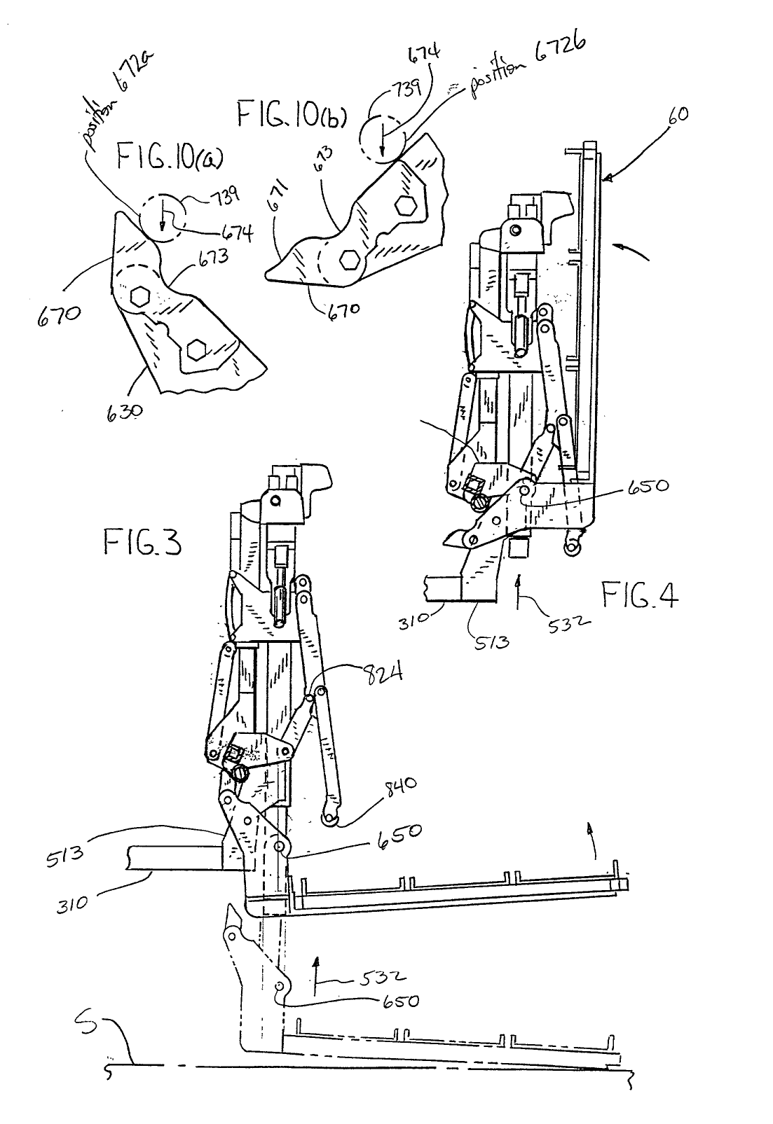

The preferred embodiment of the present invention is shown in the FIGURES. Generally, as seen in FIG. 1, the device 20 has a main mounting weldment 310 which connects the device 20 to a motor vehicle M and which holds a slide tube assembly 50. The slide tube assembly 50 is made up of an outer slide tube assembly 510 and an inner slide tube assembly 530. A platform assembly 60 is pivotably mounted to the slide tube assembly 50.

The preferred embodiment of the present invention also includes a logic mechanism 70 mounted adjacent the slide tube assembly 50. Logic mechanism 70 includes an outer logic tube weldment 710 and an inner logic tube weldment 730. A locking mechanism 80 is attached via a linkage described in more detail below to the outer slide tube assembly 510 and the inner logic tube weldment 730. Locking mechanism 80 remains in a retracted position unless the logic mechanism 70 detects cargo of a preselected weight present on the platform 60. If cargo is detected, then locking mechanism 80 extends out over the cargo as it is raised and secures the cargo to the platform 60 for storage or transportation.

Slide Tube Assembly

The slide tube assembly 50 is used to move the platform assembly 60 up and down relative to the motor vehicle M to which the device is mounted. Retracting and extending a linearly moving actuator (described in more detail below) causes the inner slide tube assembly 530 to move linearly up and down (as illustrated by arrows 532 in the FIGURES), respectively, relative to the outer slide tube assembly 510. As the actuator is retracted (that is, as the inner slide tube 511 is raised), the platform assembly 60 and the locking mechanism 80 operate in a preselected manner described in more detail below to automatically detect whether cargo is present on the platform assembly 60 and, if cargo is present, to raise and secure the cargo using the platform assembly 60 and the locking mechanism 80.

As noted above, the slide tube assembly 50 has an outer slide tube assembly 510. Assembly 510 is constructed around an outer slide tube 511 which, in the preferred embodiment, is a steel tube having a square cross-sectional shape. Tube 511 has a rectangular locking slot 514. An actuator assembly 90 (described in more detail below) is secured by welding or other appropriate means in a parallel vertical orientation to a mounting bracket 516 of the outer slide tube assembly 510. Outer slide tube 511 is connected to the vehicle mounting weldment 310 via a bracket 513. The mounting weldment 310 has a plurality of holes 311 that permit adjustable mounting of the weldment 310 to a motor vehicle M.

Actuator assembly 90 is of standard design and will only briefly be described herein. Assembly 90 includes a housing 910 and a linear actuator shaft 930. Shaft 930 is raised and lowered within housing 910 using any appropriate power source. In the preferred embodiment, the actuator 90 is a linear electric screw ball actuator. Operation of the actuator is controlled by a switching mechanism that will be described in more detail below.

Inner slide tube assembly 530 includes an inner tube 531 which, like outer tube 511 is a steel tube having a square cross-sectional shape. The inner slide tube 531 has a rectangular locking slot 534. The diameter of inner tube 531 is slightly smaller than that of outer tube 511 and inner tube 531 is designed to slide vertically and coaxially within outer tube 511. To facilitate sliding within the outer tube 511, inner tube 531 may be greased using a suitable lubricant, such as Magnalube-G” Teflon. A bracket 533 is mounted by welding or other suitable means to the bottom end of inner tube 531. Bracket 533 includes two outer vertical brackets 535 and a smaller pair of vertical brackets 537. Using a screw and lock nut, the bottom end of actuator shaft 930 is secured to brackets 537, allowing inner tube assembly 530 to be raised and lowered relative to outer tube assembly 510.

Logic Mechanism

As noted above, the logic mechanism 70 of the present invention includes an outer logic tube weldment 710 and an inner logic tube weldment 730. The logic mechanism 70 is situated directly behind the slide tube assembly 50. As will be apparent from the following discussion and the FIGURES, this centering of the logic mechanism 70 means that the forces applied within the logic mechanism during operation are not subject to offset loading as could occur if the logic mechanism was set to one side or another of the slide tube assembly and, consequently, the platform 610 which holds cargo. Moreover, the use of a separate assembly for the logic mechanism 70 provides several benefits. First, the profile of the device 20 is lower, reducing the chance that it will obstruct the view of a driver of a vehicle to which the device 20 is mounted. Second, the present invention's structure makes the device 20 easier to assemble, maintain and repair.

Outer logic tube weldment 710 includes an outer tube 711 which is a steel tube having a square cross-sectional shape and which has an outer logic spring assembly 713 housed therein. A spring retainer assembly 715 holds the spring 713 within outer tube 711. Spring 713 biases the inner logic tube 731 downward. An extrusion logic cam 717 is mounted to the rear exterior face of outer tube 711. In the preferred embodiment, cam 717 is made of suitable extrudable material, preferably aluminum.

Inner logic tube weldment 730 includes an inner tube 731 which, in the preferred embodiment, is made of steel and has a square cross-section shape. The diameter of inner tube 731 is slightly smaller than that of outer tube 711 and inner tube 731 is designed to slide vertically and coaxially within outer tube 711. To facilitate sliding within the outer tube 711, inner tube 731 may be greased using a suitable lubricant, a variety of which are known to those of ordinary skill in the art. In the preferred embodiment, the lubricant is Magnalube-G” Teflon. A fold tube weldment 733 is mounted by welding or other suitable means to the bottom end of inner tube 731. The weldment 733 includes a pair of outer brackets 735 and a pair of forwardly extending inner brackets 737. Each outer bracket 735 has a roller 739 rotatably attached thereto.

A logic follower 741 is pivotably secured to the to the rear exterior face of inner tube 731 using a bracket 736, near the bottom of the tube 731. Logic follower 741 has a spring channel 743 with a logic roller 745 rotatably mounted at the upper end of channel 743 in a horizontal orientation with its axis of rotation parallel to the rear exterior face of tube 731. A compression spring 747 is retained against the outer surface of channel 743 by any suitable means such as a retaining screw and lock nut.

As explained in more detail below, the roller 745 of follower 741 is configured to engage cam 717 as inner tube assembly 730 is raised relative to outer tube assembly 710. Cam 717 provides a preselected resistance to the outward pivoting of follower 741 against the force of compression spring 747, the upward movement of follower 741 and, consequently, the upper movement of inner tube assembly 730.

Platform Assembly

Platform assembly 60 is pivotably mounted to brackets 535 at the bottom of inner slide tube assembly 530. Platform assembly 60 includes a platform 610 having a pair of longitudinals 611, cross-members 613 and ramp weldments 615. In the preferred embodiment, the length of each longitudinal 611 is adjustable, using a plurality of screws and matching holes, thus allowing platform 610 to accommodate cargos of different sizes. When wheeled vehicles are being transported, wheel stops 617 may be attached to the platform assembly 60 to assist in holding the cargo in place. Ramp weldments 615 can use a high friction material such as grit paper to assist in providing traction for scooters and the like which are driven onto platform 610.

A pair of upright, rearward extending brackets 630 are secured to the platform 610, preferably by welding. Brackets 630 are pivotably connected to brackets 535 at pivot points 650 by suitable means such as screws, washers and locknuts. Rearward of each pivot point 650 on each bracket 630 is a follower cam 670. Follower cams 670 are secured to the brackets 630 by suitable means such as screws and jam nuts. Each cam 670 is generally crescent shaped and has two advantageous indents. The first indent 671 is immediately adjacent the rearwardmost end of cam 670. The radius of curvature of indent 671 is greater than the radius of roller 739. Moreover, in the preferred embodiment, indent 671 is selected to allow the platform 610 to move from a 6° down orientation to a 7° up orientation as the roller traverses across the first indent.

A second indent 673 inward of the first indent 671 and, in the preferred embodiment, has a smaller radius of curvature, closer and nearly identical to the radius of the roller 739. The purpose and function of these indents and the advantages they provide will be discussed in more detail below. The rollers 739 of the inner logic tube assembly 730 are positioned vertically above the cams 670 of platform assembly 60, so that as the platform 610 is raised from its lowered position, the profiled surface of each follower cam 670 will encounter a roller 739.

Hold Tight Arm Assembly

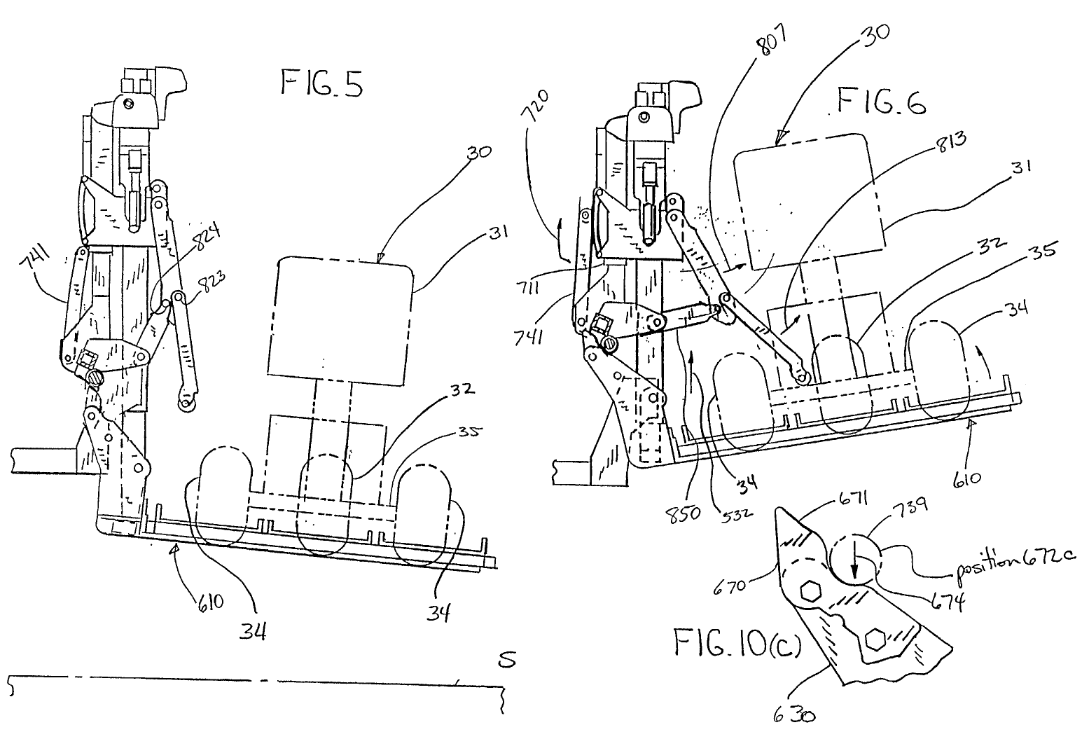

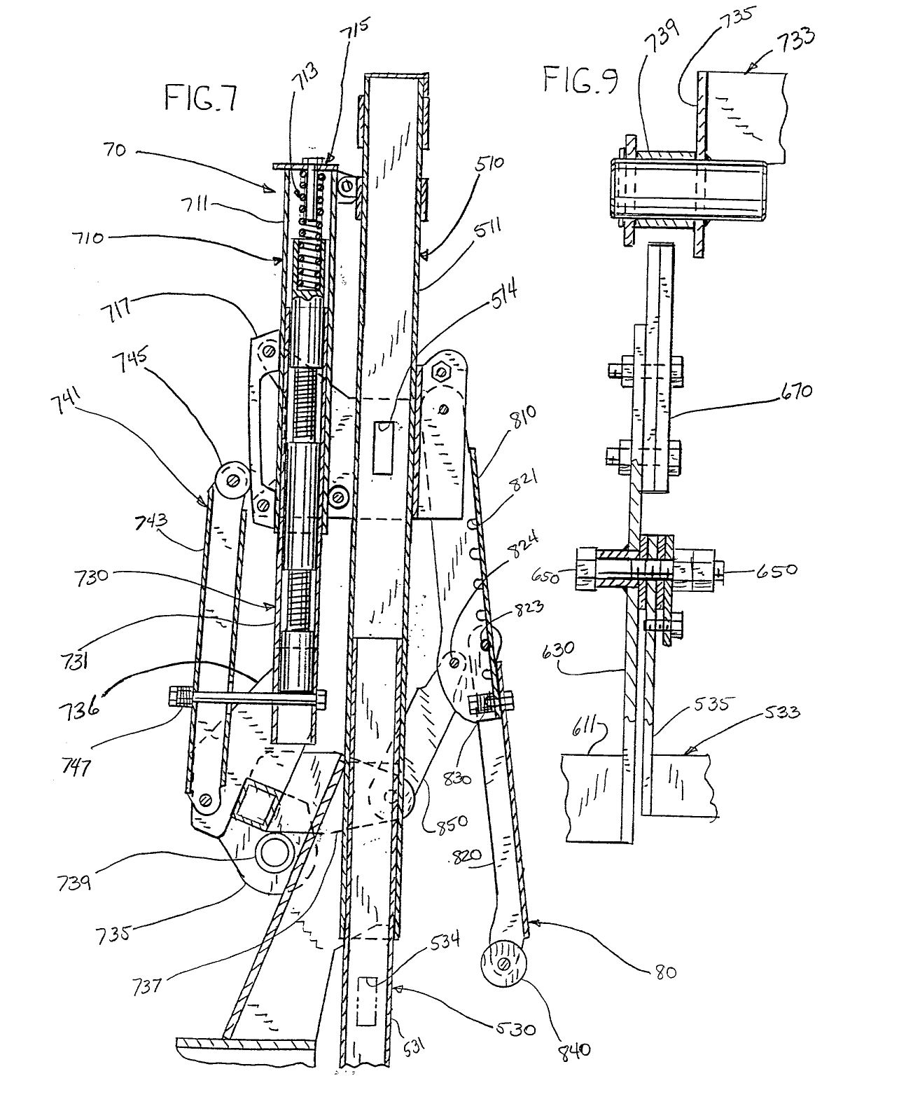

A unique hold tight arm assembly 80, shown in the FIGURES, is used to secure a scooter 30 in place for storage or transportation. The hold tight arm assembly 80 will only fully activate when a scooter 30 (or other cargo of sufficient weight) is present on the platform 610 and is designed to hold the scooter 30 firmly on the platform 610 during transportation by applying firm downward pressure to the floor 35 of the scooter 30 at a point approximately midway between the front wheel 32 and the rear wheels 34, as shown in FIG. 6. The hold tight arm 80 of the present invention does not come down over the top of the scooter 30, thereby avoiding any accidental contact with other parts of the scooter 30, such as the seat 31 or the scooter's steering mechanism and/or tiller. Instead, the hold tight arm 80 pivots outwardly from a retracted position when the logic mechanism 70 detects a scooter on the platform 610.

Hold tight arm assembly 80 includes a position bracket 805 that is welded to outer slide tube 511. An upper arm member 810 is pivotably attached to bracket 805 and is free to swing outwardly (as shown by arrow 807 in FIG. 6) from its vertical position adjacent outer slide tube 511 (the holding arm “retracted” position). A lower arm member 820 is generally telescopically secured to upper arm member 810. The two arm members 810, 820 constitute the holding arm of the present invention and are slidably adjustable using holes 821 and screws 823. A compression spring 830 is positioned behind the two arm members 810, 820 to permit lower arm member 820 to pivot outwardly (as shown by arrow 813 in FIG. 6) from upper member 810 to a limited degree against the spring force of spring 830. A holding roller 840 is rotatably mounted to the bottom of lower arm member 820 by any suitable means, preferably a bolt and jam nut.

A pair of linkage arms 850 are pivotably mounted to upper arm member 810 proximate to the connection between the upper and lower members 810, 820. The other end of each linkage arm 850 is pivotably attached to a bracket 737 on the lower end of inner logic tube 731. Because of their connection to both the outer slide tube weldment 510 and the inner logic tube weldment 730, linkage arms 850 limit the downward travel of the inner logic tube 731. As explained in more detail below, if inner logic tube 731 rises above a preselected height relative to the outer slide tube 511, the linkage arms 850 pivot outwardly, thus extending the holding arm members 810, 820 and holding roller 840 out over the platform 610 (the holding arm assembly's “extended” position).

Latch/Handle Assembly

Operation of the actuator assembly 90 is controlled by a latch and handle assembly 40. Assembly 40 includes a latch assembly 410, a handle assembly 430 in spring loaded attachment to latch assembly 410, and a switch assembly 450 attached to latch assembly 410 and handle assembly 430.

Latch assembly 410 includes a housing 411 which is pivotably connected by a bolt 412 to bracket 413, which is welded to the upper end of outer slide tube 511. A latch tab 415 is welded to the lower end of housing 411. Tab 415 interconnects with the locking slot 534 of inner slide tube 531 and the locking slot 514 of outer slide tubes 511 in a manner to be described in more detail below. Housing 411 has an open interior designed to accept and hold the handle assembly 430 and the switch assembly 450.

Handle assembly 430 includes an elongate handle 431 having a foam grip 432 at one end. A bracket 433 is rigidly secured to handle 431, bracket 433 including an elongate, generally hexagonal plate 435 and a handle safety stop tab 436. Bracket 433 is spring loaded and is attached to housing 411 using bolt 437 and spring 439. Bolt 437 is located in the middle of plate 435 and does not engage the plate 435 with threads, thereby permitting generally horizontal rotation of the plate 435 about bolt 437 as the axis.

As explained in more detail below, stop brace 441 is welded inside of bracket 413 and functions as a safety stop to prevent lowering of the platform assembly 60 unless handle assembly is raised a preselected amount and tab 415 has disengaged inner slide tube 531. Brace 441 prevents rotation of bracket 435 in a counter-clockwise direction when tab 436 is inside bracket 413. This blocking prevents the down pushbutton 457 from engaging housing 411, which allows lowering of the platform assembly 60. Plate 435 is free to rotate in a clockwise direction, even when the handle assembly 430 is down. This is needed to permit raising the platform assembly 60 in the event that tab 415 is pinned inside inner slide tube 531 by downward pressure from the inner slide tube 531 when tab 415 is inside tube 531.

Switch assembly 450 is mounted to latch assembly 410 and handle assembly 430. A switch cover 451 is mounted with screws to housing 411. A switch bracket 453 is mounted with screws to the plate 435. Switch bracket 453 includes an up button switch 455 and a down button switch 457. Button 455 is mounted along edge 435a of plate 435 and button 457 is mounted along edge 435b of plate 435. As will be explained in more detail below, the ability of plate 435 to rotate about bolt 437 and the positioning of buttons 455, 457 along edges 435a, 435b, respectively, permit selective up and down activation of the actuator to move platform assembly 60 up and down by simple manipulation of the handle assembly 430.

A relay assembly and other well known, suitable electrical connections 459 are mounted atop cover 451. A switch housing 461 encloses the entire switch assembly.

### Operation

Operation of the present invention will now be explained in connection with the preferred embodiment described above and shown in the FIGURES. Again, the preferred embodiment is provided herein for purposes of explanation and illustration and is not limiting on the scope of the present invention.

While the following discussion relating to operation will again be in the context of use of the hoist with a personal transportation vehicle, or “scooter,” this does not limit the types of cargo which the hoist can load, secure and transport. Operation of the present invention will be discussed in the context of four basic functions—raising the platform without a scooter present, lowering the platform without a scooter present, raising the platform with a scooter on it, and lowering the platform with a scooter on it.

Regardless of whether cargo is present on the platform, the orientation of the platform 610 is the same whenever it is in its lowered position, generally shown in FIG. 2. In this lowered position, the platform 610 generally is lying on the surface S below the device 20. Inner slide tube 531 is extended as far as necessary for platform 610 to reach the surface S. Inner logic tube 731 is extended approximately to the point at which the logic follower 741 is nested just below the logic cam 717, as seen in FIG. 2. The hold tight arm 80 is in its retracted position, generally being flush against the slide tube assembly 50.

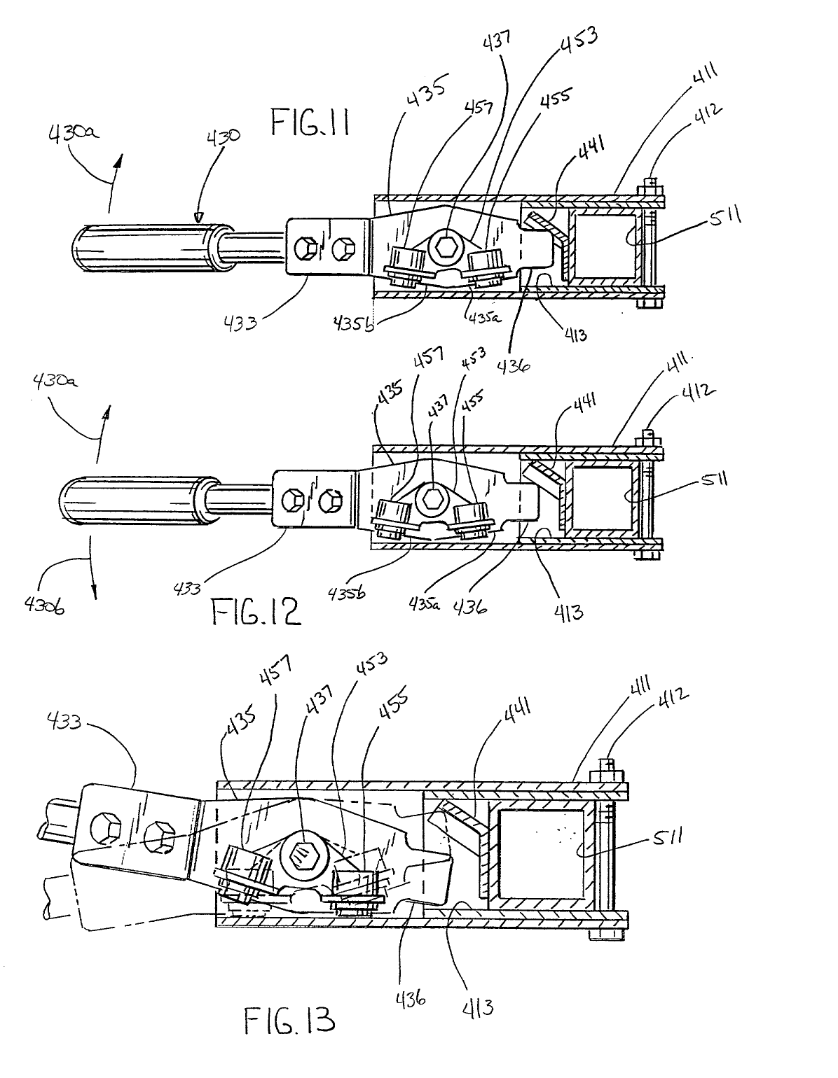

In FIG. 2, the unloaded platform 610 is on the ground and the slide tube and logic tube assemblies are extended. The operator must move the handle 430 from its resting position in the direction of arrow 430a in FIGS. 11 and 12. As the handle is rotated, pushbutton 455 engages housing 411, as seen in the solid lines of FIG. 13, thus activating the motor to retract the actuator screw.

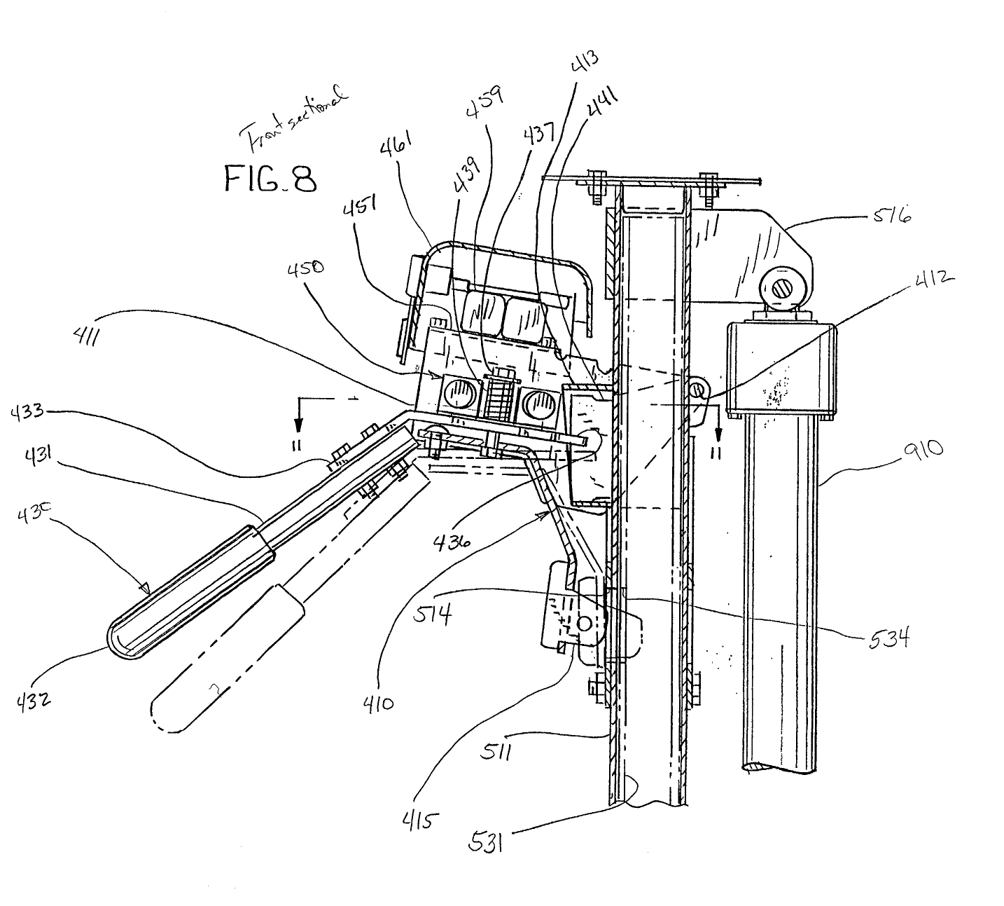

The inner slide tube 531 (and attached unloaded platform 610) begin to move upward, and eventually the follower cams 670 engage the rollers 739 of the inner logic tube 731, urging the logic follower 741 into contact with the bottom edge of the logic cam 717, if they are not already in contact. As the platform 610 is raised, each follower cam 670 engages a roller 739. The cam 670 and roller 739 first engage one another at approximately position 672 shown in FIG. 10. Arrow 674 in each FIGURE shows the perpendicular direction down to the surface S. Thus, in FIGS. 10, 10a, 10b and 10c, each arrow 674 shows the rotation of the cam 670 (and thus the platform 610) relative to the surface S.

When the logic follower 741 first contacts the bottom of the logic cam 717, the resistance to upward movement posed by the logic cam 717 is greater than the force generated by the platform cams 670 on rollers 739 (representing the weight of the unloaded platform 610), thus allowing the platform 610 to rotate into its raised storage position, shown in FIG. 4.

As can be seen in FIG. 3, the platform 610 maintains a generally horizontal orientation during the bottom portion of its travel, whether or not a scooter is present on the platform 610. However, in the preferred embodiment of the present invention, as the platform 610 is initially raised, each roller 739 moves from position 672 to position 672a, as shown in FIGS. 10 and 10a. Consequently as seen in the shift in angular position of arrow 674 in FIG. 10, and as seen in the shift in the position of platform 610 in FIG. 3, platform 610 (and follower cams 670) are rotated about 130, helping to stabilize the platform 610.

When upward movement of the inner slide tube 531 causes the logic follower 741 to engage the logic cam 717, the cam's ramped lower surface provides sufficient impedance to upward movement of the logic follower 741 to force the unloaded platform 610 to begin rotating and folding, pivoting about its pivot point 650. As the inner slide tube 531 continues its upward movement, the platform 610 continues to rotate into its storage position. During this rotation, the rollers 739 of inner logic tube assembly 730 traverse the profiled surface of follower cam 670, eventually reaching a position shown in FIG. 4. When the platform 610 is in this raised storage position, each roller 739 has moved to approximately position 672b in FIGS. 10 and 10b. As illustrated by arrow 674 in FIG. 10, the platform 610 has rotated about 90°.

Because the inner logic tube 731 does not move upward any farther when the platform 610 is unloaded, the linkage arms 850 for the hold tight arm 80 do not extend the lower end of the arm 820, thus allowing it to stay in its retracted position, as seen in FIG. 4. Once the platform 610 is fully stored, the actuator will clutch and upward movement of the inner slide tube assembly 530 will cease.

As the inner slide tube 531 reaches its upper travel limit, the tab 415 on handle 430 will engage the inner slide tube slot 534. Even if tab 415 has not been withdrawn from outer slide tube slot 514, it will nevertheless be moved out of engagement with the outer slide tube slot 514 by virtue of the cam surface on the lower edge of tab 415. With inner slide tube 531 in its uppermost position, outer slide tube slot 514 and inner slide tube slot 534 are in alignment and tab 415 can then engage both slots. Tab 415 locks the slide tubes 511, 531 into a fixed position relative to one another. In the event that inner slide tube 531 lowers somewhat, pinning tab 415 in inner slide tube slot 534, handle 430 can be rotated (in the direction indicated by arrow 430a in FIG. 11) to raise inner slide tube 531 slightly, alleviating the downward pressure applied to tab 415 and allowing the tab 415 to be withdrawn from the slide tubes' slots 514, 534.

The platform 610 is now in its unloaded, raised, storage position. To lower the platform 610, an operator must lift the handle 430 out of engagement with safety stop plate 441, and rotate the handle 430 in the direction indicated by arrow 430b in FIG. 12. Again, if the actuator has extended slightly (i.e., backdriven), then the loading on tab 415 can be alleviated by raising the inner slide tube 531 slightly. Once the handle 430 is raised and rotated, the down pushbutton 457 is depressed, allowing actuator to extend and lower the inner slide tube 531. Since the inner logic tube 731 is essentially in its lowermost travel position (with logic follower 741 nested at the bottom of logic cam 717), the inner logic tube 731 will remain in place. As inner slide tube 531 descends, rollers 739 of inner logic tube assembly 730 retrace their path on the follower cam 670, thus allowing platform 610 to unfold as it descends. During the last portion of the rollers' 739 traversal of the follower cam 670, the small indent 671 causes platform 610 to rotate from an inclined angle of several degrees to a declining angle of several degrees, as seen in FIG. 3.

With the platform on the loading surface S (e.g., the ground), a scooter 30 or other cargo can be loaded onto the platform 610. Once the cargo is situated on the platform 610, the handle 430 is rotated in the direction of arrow 430a of FIG. 11, engaging the up pushbutton 455 and retracting the actuator. As the platform 610 rises, the follower cams 670 will engage the rollers 739 of the inner logic tube assembly 730. The weight of the platform 610 itself plus the weight of the scooter 30 are applied to the rollers 739 by cams 670, thus pushing the inner logic tube 731 upward, rather than allowing traversal of the surfaces of cams 670 and any rotation of the platform 610. Two forces encounter each other during this phase of operation—the upward force from the loaded platform 610 (that is, the torque representing the weight of the scooter/cargo 30 on the platform 610 generated about the pivot point 650) and the downward force applied by the logic cam 717 on the logic follower 741 engaging the logic cam 717 (that is, the spring loading of the logic follower 741 that has to be overcome to permit the logic follower 741 to traverse the lower ramp portion of the logic cam 717). In the situation where cargo of at least a preselected minimum weight is present on the platform 610, the spring loading of the logic follower 741 is overcome and the logic follower 741 climbs the logic cam 717, as shown by the arrow 720 in FIG. 6.

When the bracket 736 of inner logic tube assembly 730 encounters the lower edge of outer logic tube 711, the downward force applied to cams 670 by rollers 739 is sufficient to induce movement of the rollers 739 across the surfaces of cams 670. As seen in FIG. 10, the rollers 739 traverse the first, smaller indent 671 of the follower cams 670. Again, this rotates the outer edge of the platform 610 up approximately 13°.

When the rollers 739 have traversed the follower cams 670 to the point where the rollers 739 are positioned in the larger indents 673 of the cams 670, the actuator 90 has reached the end of its travel and the platform is held in its upper loaded position. The rollers 739 remain in position 672c, shown in FIGS. 10 and 10c, with the platform 610 maintaining the slight angular tilt shown in FIG. 6 and shown by arrow 674 in position 672c of FIG. 10.

Because the rollers 739 do not travel farther along the cam surface of follower cams 670, and instead remain nested in the large indents 673, the platform 610 does not rotate any farther. Due to the novel construction of the indents 673 of the follower cams 670, much of the torque generated by the weight of the scooter/cargo 30 on the platform is split into vertical and horizontal force components applied to the follower cams 670. The horizontal force is applied to roller 739 at about point 739h and is absorbed by the logic tube assembly 70, while the relatively small vertical force component is applied to roller 739 at about point 739v and is handled by the actuator 90. In this way the actuator 90 is protected against prolonged exposure to heavy loads, especially when the cargo is being transported. The actuator 90 “sees” only the vertical component applied at point 739v.

While the loaded platform 610 is being lifted, the hold tight arm 80 is extended in a novel manner. As the logic follower 741 climbs the logic cam 717, thus allowing inner logic tube 731 to move farther up into the outer logic tube 711, the linkage arrangement 810, 850 of the hold tight arm 80 is compressed. That is, as the inner logic tube 731 retracts into the outer logic tube 711, the upper end of upper arm member 810 (pivotably connected to the outer logic tube 711) and the ends of linkage arms 850 (pivotably connected to the inner logic tube 731) move closer together, thus pushing their mutual pivot connection 824 outward. This in turn extends the hold tight arm 810, 820 out over the platform 610 and scooter 30 as they are being raised, generally along arrows 807, 813 of FIG. 6.

As seen in FIG. 6, the lower arm member 820 and holding roller 840 of hold tight arm 80 engage the upper surface of the scooter's floor pan 35, avoiding contact with any obstacles such as the scooter's steering mechanism and controls or the seat 31. As the scooter 30 and platform 610 are raised, the compression spring 830 of the hold tight arm 80 permits limited pivoting of the lower arm member 820 relative to the upper arm member 810, creating a firm, but flexible, holding force on the floor 35 of the scooter 30. By selecting the compression force of the spring 830, the amount of pressure applied to the scooter floor 31 is limited. By taking into account the height of the floor 35 of the scooter 30, the desired pressure to be applied, and the travel limit of the actuator 90, the length of the combined hold tight arm 80 (that is, the two arm members 810, 820 which are slidably adjustable using holes 821 and screws 823) is selected to achieve appropriate holding pressure on the scooter floor 35. In this way, a scooter 30 or other cargo can be held in place on the platform 610 during storage and/or transportation. Rollers 739 remain nested in the large indents 673 of the follower cams 670, in the position generally shown in detail in FIG. 10C.

Variations, modifications and other applications of the present invention will become apparent to those presently of ordinary skill in the art after reviewing the specification in connection with the FIGURES. Therefore, the above description of the preferred embodiment is to be interpreted as illustrative rather than limiting. The scope of the present invention is limited, if at all, solely by the scope of the claims which follow.

What is claimed is:

1. A device for raising and securing a scooter to the outside of a vehicle, said device comprising:
(A) a slide tube assembly comprising:
(1) an outer slide tube assembly comprising:
(a) an outer slide tube; and
(b) means for mounting said outer slide tube to a vehicle; and
(2) an inner slide tube assembly comprising an inner slide tube slidable within said outer slide tube;
(B) a platform assembly attached to a pivot bracket at the base of said inner slide tube and pivotable between an open position and a closed position, said platform assembly comprising:
(1) a load bearing platform;
(2) follower cam means to move said inner logic tube assembly within said outer logic tube assembly; and
(3) pivotable mounting means intermediate said platform and said follower cam means;
(C) a logic tube assembly comprising:
(1) an outer logic tube assembly comprising:
(a) an outer logic tube; and
(b) a logic cam mounted to the rear surface of said outer logic tube;
(2) an inner logic tube assembly comprising:
(a) an inner logic tube slidable within said outer logic tube; and
(b) a spring loaded logic roller engaging the rear surface of said outer logic tube
(D) a hold tight arm assembly comprising:
(1) an arm having a first end and a second end, said arm first end being pivotably attached to said outer slide tube, said arm being movable between a retracted position and an extended position;
(2) a linkage having a first end and a second end, said linkage first end being pivotably attached to said arm at a point intermediate said arm first and second ends and said linkage second end being pivotably attached to said inner logic tube;
(E) drive means for raising and lowering said inner slide tube; wherein said device
automatically detects whether cargo of a preselected minimum weight is present on said platform;
controls pivoting of said platform between said open and closed positions; and
controls movement of said arm between said retracted and extended positions.

2. A securing arm assembly to hold cargo on movable platform, said securing arm assembly comprising:
a) a platform movable between a first position and a second position;
b) logic means, connected to said platform, for automatically detecting whether cargo is present on said platform;
c) a securing arm having a upper end and a lower end, said securing arm upper end being pivotably attached to said logic means, and said securing arm lower end being movable between a retracted position, wherein said securing arm lower end is clear of said platform, and an extended position, wherein said arm lower end is not clear of said platform;
wherein said lower end is in said retracted position when said platform is in said first position; further wherein said lower end is in said extended position only when said platform is moved to its second position and said logic means detects cargo on said platform.
